(19) United States
(12) Patent Application Publication
(10) Pub. No.: US 2025/0111634 A1
(43) Pub. Date: Apr. 3, 2025

(54) Method and Modification Device for Modifying Surface-Based Image Data of a Three-Dimensional Geometric Model

(71) Applicant: EOS GMBH ELECTRO OPTICAL SYSTEMS, Krailling (DE)

(72) Inventor: Jan Orend, Starnberg (DE)

(21) Appl. No.: 18/903,949

(22) Filed: Oct. 1, 2024

(30) Foreign Application Priority Data
Oct. 2, 2023 (DE) 102023126837.6

(51) Int. Cl. G06T 19/20; G06T 17/20

(52) U.S. Cl. CPC G06T 19/20; G06T 17/20; G06T 2219/2004

(57) ABSTRACT

Disclosed is a method for modifying surface-based image data of a three-dimensional geometric model suitable for the additive manufacturing of a component. The method includes creating a number of voxel grids, and for each, determining position information and assigning the position information to the respective voxel, assigning an individual index to at least some of the surface segments of the image data, and assigning the index of the nearest surface segment to the respective voxel. Additionally, or alternatively to the above, the method can include determining a distance of the respective voxel to the surface of the model and assigning corresponding distance information to the respective voxel and outputting the voxels with the information assigned to them.

### TECHNICAL FIELD OF THE INVENTION

The invention relates to a method and a modification device for modifying surface-based image data of a three-dimensional geometric model, in particular suitable for the additive manufacturing of a component. The invention also relates to a control device for a manufacturing device for the additive manufacturing of a component in a manufacturing process, respectively to a corresponding manufacturing device, a data set comprising manifold data of a model as well as a manufacturing procedure for the additive manufacturing of a component.

### BACKGROUND OF THE INVENTION

The creation of (virtual) three-dimensional, geometric models has become increasingly important in recent years. Such (virtual) models are essential not only for purely graphical representation, but also for the creation of real components using automated manufacturing procedures. For additive manufacturing procedures, for example, the components to be manufactured are first created as a model using a CAD program, then saved as surface-based information (often as an STL file) and this information is then used to create component layers so that the component can be built up according to the model in layers.

A serious disadvantage, especially for complex components, is that files with surface-based information can have a very large memory requirement and cannot be modified or can only be modified very poorly. For example, if the surface-based information is available as a pure triangular mesh (e.g. in an STL file), it is difficult to make changes to the model, especially using Boolean operators such as a merging, a cut or the formation of an intersection. In addition, it is just as difficult to derive variables such as distances from an STL file.

On the other hand, these changes are easily possible with implicit geometries, i.e. functions for shape elements. For example, common CAD programs usually provide basic elements such as cubes, cylinders or spheres, from which complex models can be formed using Boolean operators or other mathematical functions (e.g. edge rounding). Simple trigonometric functions can also be used to define a very complex model.

Implicit geometries can also be used to generate surface information or layer information (contours or raster graphics) in any resolution, making them particularly suitable for manufacturing procedures.

Finally, it may also be the case that implicit geometries are not available at all for a component, e.g. if this component has been transferred into a (virtual) model using three-dimensional scanning processes, or if special geometries are available.

### SUMMARY OF THE INVENTION

The objective of the invention is to overcome the disadvantages of the prior art and to provide a method and a modification device by means of which surface-based information on a model is modified in such a way that subsequent modification of the model is possible in a simple and fast manner. In particular, it is an aim of the invention to optimize the computational effort and/or memory requirements for a subsequent modification of a model defined by surface-based information. A particularly preferred task of the invention is to be able to combine a model exported as an STL file or as a corresponding file with implicit geometries.

This task is solved by a method, a corresponding modification device, a control device, a manufacturing device, a data set, as well as a manufacturing procedure and by a computer program product.

The method according to the invention is used for modifying surface-based image data of a three-dimensional geometric model, suitable for the additive manufacturing of a component. Surface-based image data is well known in the prior art and comprises (in particular exclusively) the above-mentioned surface-based information. This is surface data of the model with geometric information about a plurality of surface segments (e.g. triangles), which together form the surface of the model.

The surface-based image data is therefore data that describes the surface of a 3D body, in particular without including its volume (only indirectly through the arrangement of the surface segments, which can also be referred to as “facets”). They preferably represent mesh coordinates (points) of a three-dimensional model, which are connected by means of (especially straight) edges and in particular form polygons. The image data can also include additional information, e.g. data on the surface normals of the surface segments. A widely known format for surface-based image data is the so-called “STL format”, whereby the acronym “STL” originally stood for “stereolithography”, but is now also interpreted as “Standard Triangle Language” or “Standard Tessellation Language” (with English “tessellation”=“parquetisation”). The STL format describes the surface of 3D objects using triangular facets. Each triangular facet is characterized by the three corner points and the corresponding surface normal of the triangle. If the three corner points are arranged anti-clockwise when looking at a triangular surface, the surface is assumed to be the outside of a body. The surface normal always points outwards from the body. Even if a division into triangles is particularly advantageous, the image data does not necessarily have to be fixed to this.

In short, the image data includes information about the surface of a 3D body but preferably no information about the implicit geometry of the body.

The method according to the invention comprises the following steps:
creating a number of voxel grids each comprising a plurality of voxels, wherein each voxel grid comprises and surrounds at least a portion of the surface segments,
for the voxels of the voxel grids:
a) determining position information which indicates whether the respective voxel lies inside or outside the contours of the model and assigning the position information to the respective voxel; and/or
b) assigning an individual index to at least some of the surface segments of the image data so that each indexed surface segment is distinguishable from all other indexed surface segments of the model by means of its index, and assigning the index of the nearest surface segment to the respective voxel, and/or
c) Determining a distance of the respective voxel to the surface of the model and assigning corresponding distance information to the respective voxel,
Outputting the voxels with the information assigned to them.

As mentioned above, the image data comprises surface segments, e.g. triangles. For a better understanding, it can be assumed that the image data consists of a large number of triples of coordinates of points, each of which indicate the three corner points of a triangle.

At least some of the surface segments, preferably all surface segments, are assigned an individual index. In order to completely modify the image data of the body, it is useful if an individual index is assigned to all surface segments. This index can be, for example, a consecutive number or an individual character string (e.g. an address). However, it can also be a coordinate, e.g. that of the balance point or the center of a surface segment.

For an assignment of the voxels considered in the method, it is preferred that at least some of the surface segments are indexed with an index and that each indexed surface segment can be distinguished from all other indexed surface segments of the model by the index. The indices should therefore all be different from each other.

The term “voxel” is made up of the English “volume” (vox) and “element” (el) and in computer graphics refers to a grid element, i.e. a volume, in a three-dimensional grid. In two-dimensional raster graphics, the term “pixel” (for “picture element”) has become established for the points of an image. A voxel is the three-dimensional equivalent of a pixel. For the purposes of the invention, a voxel is a (particularly cubic) volume element in a three-dimensional grid.

At least one grid (“voxel grid”) is now created, which has (in particular indexed) surface segments in its interior. The choice of words “comprises and surrounds” is intended to clarify that the grid extends beyond the surface segments, but is not only outside the surface segments (like a surrounding skin), but is also defined in the volume of the surface segments (i.e. also runs through the surface segments). Preferably, the respective surface segments (in particular all surface segments of the body) are surrounded by a three-dimensional bounding box, and the volume surrounded by this bounding box is completely subdivided by the grid into voxels.

Special steps are now carried out for the voxels of the voxel grid, i.e. preferably for each individual voxel. Voxels can be summarized in groups for which the steps would obviously result in identical information. These are, for example, voxels that are assigned the same values. This case will occur very rarely for distance information, but more often for indices and position information. It is preferred to summarize the different types of information (distance, position information, index) separately.

At first, the position information of the respective voxel is determined. This position information indicates whether the respective voxel lies inside or outside the contours of the model (i.e. the 3D body). If the image data comes from an STL file, the arrangement of the corner points, for example, can be used to determine where is outside and where is inside. The surface normals of the surface segments can also be used for this purpose. In particular, the sign can be determined directly from the surface normals. Another very robust but computationally intensive method is to determine all intersection points of a line from the point under consideration to a point that is certain to be outside. Another favored method is to determine the contour in a plane (the intersection of the plane with the component surface) in which the point lies, and then use a winding-number-method to determine the sign from the contour. However, if only a voxel model or a raster graphic is to be filled with the position information, this can also be done with a “flood fill”, for example. To do this, you start with a voxel that you know for sure is inside. To do this, you can use the normal of the triangle and select a point that lies on the inner side in the immediate vicinity of the triangle. All neighboring points are then filled from this point, if they are not intersected by a triangle. The same is repeated for the neighboring points until all respective voxels have been processed.

In a preferred simple case, the position information can take two values, a first value (e.g. “−” or “true”) if the voxel lies inside the model and a second value (e.g. “+” or “false”) if the voxel lies outside the model. A voxel lies inside (outside) the model if a predominant part of the voxel lies inside (outside) the model. Alternatively, a voxel lies inside (outside) the model if the center of the voxel lies inside (outside) the model. It is also possible to define whether voxels through which a surface segment runs (i.e. voxels that are intersected by the surface segment of the model) must be assigned the same position information as voxels inside or outside the model. This means, for example, that it can be defined that the position information of the voxels that are intersected by a surface segment of the model take the same value as the voxels that lie within the model (e.g. “−” or “true”). Alternatively, it can be defined that the position information of the voxels that are intersected by a surface segment of the model take the same value as the voxels that lie outside the model (e.g. “+” or “false”).

In another preferred case, the position information may take three values depending on whether the voxel is (entirely) inside or outside the model or whether the surface of the model cuts the voxel (i.e., the voxel is on the surface of the model). In this case, the position information can have a first value (e.g. “−”) if the voxel lies inside the model, a second value (e.g. “+”) if the voxel lies outside the model and a third value (e.g. “0”) if the surface segment passes through the voxel (i.e. if the voxel is intersected by a contour or a surface segment of the model).

This position information is then assigned to the respective voxel. This can be done, for example, by storing it directly as voxel information or by linking it to the respective voxel, e.g. using a pointer. In a three-dimensional computer graphic, a voxel has a coordinate and color information. The position information can, for example, be stored in a color channel of such a voxel.

In addition or as an alternative to the position information (preferably in addition), the index of the nearest surface segment is also assigned to the respective voxel. The assignment can be made according to the position information (e.g. also in a color channel). How the distance of a point (the voxel) to a surface is determined is sufficiently known in the state of the art. In geometry, the shortest distance is always calculated as the distance. The index of the surface segment that lies on a straight line that marks the shortest distance between the surface segments and the respective voxel, is assigned to the respective voxel. However, an index can also be assigned without determining the distance, e.g. by assigning the index of the relevant surface segment to all voxels within a bounding box around the surface segment and only carrying out more detailed investigations for voxels to which two or more indices are assigned. The term “distance” can refer in particular to the square distance, which simplifies calculations based on the Pythagorean theorem. Voxels that are intersected by several surface segments are preferably assigned not just one index, but a list with the indices of all surface segments that intersect this voxel. When examining the indices of neighboring voxels, the smallest distance to all surface segments with the indices is then preferably determined.

It is particularly preferred to assign both the position information and the index to a voxel.

In addition or as an alternative to the position information and/or the index, the distance of the respective voxel to the surface of the model is determined. This has already been described in the previous paragraph. The assignment of corresponding distance information to the respective voxel can be carried out in the same way as the assignment of the position information, e.g. in a color channel. Particularly preferably, the index of the nearest surface segment is assigned to a voxel, the distance between the voxel and the indexed surface segment is calculated and the calculated distance and the index of the indexed surface segment are assigned to the voxel.

The voxels with the information assigned to them are then outputted, e.g. saved or used for further calculations. Basically, the voxels can be used to determine an implicit geometry or directly for the execution of Boolean operators. If the voxels contain information on distances, these could already describe an implicit geometry. Just as with implicit surfaces described by functions, Boolean operations can be realized by simple min/max operations, e.g. minimum distance to two different components for a merging.

A modification device according to the invention is used for modifying surface-based image data of a three-dimensional geometric model suitable for the additive manufacturing of a component. The image data comprises surface data of the model with geometric information about a plurality of surface segments, which together form the surface of the model. The modification device comprises the following components:
a data interface designed to receive the image data,
a limiting-unit designed for creating a number of voxel grids each comprising a plurality of voxels, wherein each voxel grid comprises and surrounds at least a part of the surface segments,
a process-unit designed for:
a) determining position information indicating whether the respective voxel lies inside or outside the contours of the model and assigning the position information to the respective voxel; and/or
b) assigning the index of the nearest surface segment to the respective voxel, wherein the modification device comprises an index-unit adapted for assigning an individual index to at least some of the surface segments so that each indexed surface segment is distinguishable by its index from all other indexed surface segments of the model,
and/or
c) Determining a distance of the respective voxel to the surface of the model and assigning corresponding distance information to the respective voxel,
a data interface designed for outputting the voxels with the information assigned to them.

The model can now be modified with this modified image data, e.g. a structure can be added so that the component created later also has this structure.

The mode of operation of the individual components has already been described in detail above in the context of the method. The modification device is preferably designed to carry out the method according to the invention.

Control data according to the invention for controlling a manufacturing device for additive manufacturing is created from modified image data. The modified (and possibly processed) image data is preferably converted back into surface-based image data and control data is created from it. The creation of control data from surface-based image data (or other image data) is known in the prior art. In addition to the control data, variables (e.g. the distance to the bottom or top surface of the component) can be determined from modified image data. The control data and/or additional control data can be created based on the variables determined from the modified image data.

A control device according to the invention for a manufacturing device for the additive manufacturing of a component in a manufacturing process, in which building material, preferably comprising a metal powder, is built up in layers in a construction field, and selective solidification of building material takes place in each case between the application of two material layers of building material by irradiating the building material with at least one energy beam by means of an irradiation device, comprises a modification device according to the invention.

A manufacturing device according to the invention for the additive manufacturing of at least one component in an additive manufacturing process comprises
a feeding device for applying layers of building material to a construction field in a process space,
an irradiation device for selectively solidifying building material by irradiation with at least one energy beam, in particular between the application of two layers of material, and
a control device according to the invention.

A data set according to the invention comprises surface data of a model together with data of a plurality of voxels with the information assigned to them, which have been created by means of a method according to the invention, in particular control data for controlling a manufacturing device for additive manufacturing, which have been generated based on the voxels according to a method according to the invention.

In a manufacturing procedure according to the invention for the additive manufacturing of a component, building material, preferably comprising a metal powder, is built up in layers in a construction field and selectively solidified between the application of two material layers of building material, namely by irradiating the building material with at least one energy beam based on image data which has been modified by means of a procedure according to the invention. To create layer structures of the component, the energy beam is moved along a number of parallel consolidation paths across the construction field within defined areas of the layer structure in accordance with corresponding control data (which is based on the modified image data).

In particular, the invention can be realized in the form of a computer unit with suitable software. The computer unit can, for example, have one or more co-operating microprocessors or the like for this purpose. In particular, it can be realized in the form of suitable software program parts in the computer unit. A largely software-based realization has the advantage that previously used computer units, in particular control devices of production devices, can also be easily updated by a software or firmware update in order to work in the manner according to the invention. In this respect, the task is also solved by a corresponding computer program product with a computer program which can be loaded directly into a memory device of a computer unit, in particular a control device, with program sections to carry out all the steps of the method according to the invention when the program is executed in the computer unit. In addition to the computer program, such a computer program product may comprise additional components such as documentation and/or additional components, including hardware components such as hardware keys (dongles, etc.) for using the software. A computer-readable medium, for example a memory stick, a hard disk or another transportable or permanently installed data carrier, on which the program sections of the computer program that can be read in and executed by a computer unit are stored, can be used for transport to the computer unit and/or for storage on or in the computer unit.

Further, particularly advantageous embodiments and further developments of the invention result from the following description, whereby individual features of different embodiments or variants can also be combined to form new embodiments or variants.

According to a preferred method, voxels that are assigned the same index and/or the same position information are combined to form a group. This simplifies and accelerates subsequent calculations, as sometimes only a single calculation needs to be performed for the entire group, i.e. for all voxels in the group together. Preferably, voxels that are assigned distance information are treated as individual voxels. These voxels are therefore preferably not assigned to a group with other voxels.

Preferably, the information assigned to the voxels is assigned directly to the voxels or a group. This means that the voxels or the groups each contain the information assigned to them or that the voxels (or groups) are assigned a reference that leads to this information, e.g. a pointer.

According to a preferred method, several voxel grids of different resolutions and/or different sizes are created, and distance information and/or an index and/or position information is assigned to the respective voxel depending on the voxel grid in which this voxel is located. It may by all means be that only an index is assigned to voxels of one voxel grid and position information and/or distance is assigned to voxels of another voxel grid, preferably together with an index. It is preferred that at least a first voxel grid and a second voxel grid are defined in such a way that the first voxel grid has a coarser resolution than the second voxel grid and/or is larger than the second voxel grid, whereby in the latter case the second voxel grid is preferably located within the first voxel grid.

Preferably, the assignment of information to a voxel is dependent on a threshold value related to a distance value. In particular, a distance value (and preferably also position information and/or an index) is assigned to voxels within the threshold value, i.e. with a distance smaller than the threshold value, and to voxels outside the threshold value, only an index and/or position information is assigned. However, the voxel grids can also serve as limiting areas and thus basically fulfil the task of such a threshold value. If both a threshold value and several voxel grids are used, an individual threshold value may by all means apply in each voxel grid. In a preferred practical application, only the position information and/or the index are stored in voxels of a coarse voxel grid and the distance information (possibly together with index and/or position information) is stored in the voxels of a fine grid.

With regard to the aforementioned threshold value, according to a preferred method, distance information is only assigned to voxels that have a distance less than a predetermined maximum distance from the surface. This predetermined maximum distance would then be a threshold value. Preferably, the maximum distance in the first voxel grid is greater than in the second voxel grid. Preferably, position information and/or an index is assigned to the voxels in the first voxel grid and no distance information. Preferably, each voxel that is assigned distance information is also assigned at least one piece of position information.

According to a preferred method, a voxel grid is parsed voxel by voxel to determine the distance and/or index and/or position information, the relevant value is determined and assigned for each voxel of the voxel grid, and when determining the distance, the shortest distance to the surface of the model is preferably determined on the basis of each parsed voxel.

According to a preferred method, the model is parsed surface segment by surface segment to determine the distance and/or index and/or position information, and the value for each voxel is determined for the voxels surrounding the respective surface segment and assigned to the respective voxel.

It is preferred for the voxels surrounding a first voxel to be checked to see whether they have been assigned an index of a surface segment other than the first voxel. In the positive case, the distance between the first voxel and the other surface segment is also determined and it is determined whether this distance is smaller than the distance to the originally assigned surface segment. This minimizes errors when assigning the information.

According to a preferred method, the surface-based image data (or “surface data”) of the model are mesh coordinates of three-dimensional data models, in particular designed for manufacturing by means of additive manufacturing procedures. Preferably, the surface data is data for stereolithography or a Standard Triangle Language (or Standard Tessellation Language). For example, STL files are preferably used.

According to a preferred method, the outputted voxels with the information assigned to them are used to modify the model. This is a very important possible application of the method. In the introductory section, it was stated that surface-based data is not optimal for subsequent changes to a component or cannot be used at all. With the voxels now additionally provided with information, an effective modification of the component can now be carried out, e.g. the component can be structured or changed using other bodies, in particular using Boolean operators. Preferably, the method is applied to several models and these models interact with each other, in particular using Boolean operations. In particular, two models are merged (logical OR), subtracted from each other (logical AND with an inverted input for the voxels of the model to be subtracted) or an intersection of the models is formed (logical AND). It should be noted that a model can be an implicit surface described as a mathematical function. An operation can then also be carried out using these distance functions. For example, a merging of a model A with a model B, where A and B are distance functions, can be calculated. A and B can be purely mathematical functions or a distance to a grid that is calculated using the information from the voxel model. The modifications of models can be arbitrarily nested.

The model can therefore be expanded or structured at a later date.

According to a preferred method, voxels of a voxel grid are assigned an index of a surface segment. According to the invention, this is the nearest surface segment in each case. Preferably, this applies to the finest voxel grid, i.e. the one with the finest resolution. Here, however, a grid can also be linked to the index only in the edge area, i.e. in the area of the surface segments.

The following steps are then carried out for a large number of points:
Select a point in a voxel of the voxel grid,
Determine the distance of the point from the surface segment to which the respective index is assigned,

With regard to the selection, a point can be selected in advance and it can be checked whether this point is located in a voxel of the voxel grid. If yes, the procedure is carried out; if no, this point can be assigned position information, for example. However, a voxel can also be viewed and points in the voxel can be deliberately selected.

The following steps are also preferably carried out:
Check whether the index differs from the index of a neighboring voxel, and if so: Determine the distance of the point from the surface segment to which the relevant index of the neighboring voxel is assigned,
Compare the distances determined and select the smallest distance.

This allows the distance of the point from the surface to be determined even more precisely.

According to a preferred embodiment of the method, the voxels of the voxel grid are additionally assigned distance information. Preferably, the distance of the point from the surface segment is then only determined if the distance of the voxel that can be read from the distance information falls below a maximum distance. A maximum distance is, for example, a defined threshold value, which can be selected in particular depending on the voxel size and/or a surface property. If, for example, the amount of distance information stored in the voxel falls below a maximum value (a defined threshold value), then an exact calculation of the distance is performed. “Determining the distance” in this case therefore means that an exact calculation of the distance is carried out. Further preferably, the distance information and/or the position information of the voxel is assigned to the point if the distance of the voxel that can be read from the distance information exceeds a maximum distance (a defined threshold value). “Determining the distance” in this case therefore means that the distance of the voxel that can be read from the distance information is determined (without an exact calculation being carried out).

According to a preferred embodiment of the method, position information is additionally assigned to the voxels of the voxel grid; preferably, this position information is then assigned to the point. In the case that the position information indicates a position of the voxel on the edge, the corresponding position information for the point is preferably also calculated.

A function F(P) is therefore used that provides a distance and preferably also position information for a point P(x,y,z) in space using the voxel model. Such a function is generally known in which, for example, the distances to surface elements are determined using simple trigonometric length determinations around the point. The special feature of the invention is that the index information is used to select a specific surface segment, which significantly reduces the computational effort. It is therefore possible to determine a distance between the surface of the model and a point P(x,y,z) in 3D space based on the voxel grid in a resource-saving manner. The distance determined can be used to generate commands (slicing, support structures, etc.).

For the point P, the voxel V in the grid with the finest resolution is preferably searched for. In addition to the index, position information L can be assigned to the voxel, which simplifies the decision as to whether the point is outside or inside the component. As mentioned at the beginning, searching for a voxel means that the point P is assigned to a voxel in which the point P is located or that the point P is assigned to the nearest voxel if the point P is not located within a voxel. The fact that a voxel with the finest resolution is preferably searched for means, for example, that a point P that is simultaneously located in two voxels is assigned to the voxel with the finest resolution from the two voxels in which the point P is located. The voxel that is searched for first or to which a point P is assigned first is also called the “home voxel” in the following.

The computational effort can be further reduced if the voxel also includes distance information and a calculation for the point is only performed if the distance of the voxel to the nearest surface element is less than a certain amount. Otherwise, the distance information of the voxel or its position information can be assigned to the point.

Once the distance from P to the surface element (closest to the voxel) has been calculated, the essentials for this point have basically been determined. However, it may be the case, e.g. for an edge point of the voxel, that another surface element is closer to this point. The index of this other surface element would then also have to be assigned to a neighboring voxel. It is therefore preferred to calculate the distances from P to all surface elements to which the indices of the neighboring voxels point, if these differ from the index of the “home voxel”. The minimum of the distances determined is then output as the distance value for this point.

However, the distance P can also be interpolated from a distance information of the “home voxel” and/or from the distance information of the neighboring voxels, preferably by bilinear interpolation. In particular, the distance P can be interpolated from the distance information of the neighboring voxels if no distance information has been assigned to a “home voxel”.

A modified model (i.e. a modification of the model whose surface data was initially available) essentially comprises a distance function for each point to the surface. This distance function is composed of mathematical functions and distance functions as described above. Points that are far from the edge do not have to be exactly covered by the distance function. Simple position information (inside/outside) may be sufficient here. In a further step, the distance function for the modified model can be used to directly determine the contour for any cutting plane or cutting surface (e.g. for printers that can print non-planar) or to generate a mesh. Depending on the system used, this can save time and effort. There are well-known algorithms for this, such as Marching Square or Dual Contouring.

In practice, one can proceed as follows: A point is selected in a voxel to which distance information has been assigned. If the point is located in several voxels of different grids, the voxel of the finest grid should be selected. If the point is in the center of a voxel, the distance information of the voxel can simply be assigned to this point. However, this case is rare and a check may take longer than a distance calculation for this point. If the distance information of the voxel (in which the point is located) falls below a threshold value, the distance of the point to the surface element is determined using the identical index. If the distance information exceeds the threshold value, it is assigned to the point and no separate distance calculation takes place.

If no index is assigned to the voxel, the distance between the point and the model can be calculated “directly”, i.e. without accessing information contained in the voxels. In particular, this calculation can be performed using an alternative (e.g. simplified) function (“substitute function”). Alternatively, a distance between the point P(x,y,z) and a bounding box can be calculated. Furthermore, a distance between the point and a polynomial function that describes a similar (e.g. simplified) form to the model can be calculated in the same way. It is also possible to determine the distance between the point and the center of the model.

According to a preferred method, the outputted voxels with the information assigned to them are used to create sectional planes of the model, in particular for an additive manufacturing procedure. Since surface data of the model is often created again for this purpose, this is particularly advantageous if the cutting planes are created from a modified model as described above.

According to a preferred method, the outputted voxels with the information assigned to them are used to generate control data for a manufacturing device for the additive manufacturing of a component in a manufacturing process. In this manufacturing process, building material, preferably comprising a metal powder, is built up in layers in a construction field and selective solidification of building material is carried out between the application of two layers of building material by irradiating the building material with at least one energy beam.

In practice, as already indicated above, the image data are preferably the coordinates of corner points of polygons (the surface segments), especially of triangles, and possibly their surface normals or directions of surface normals (e.g. unit vectors pointing outwards). This image data describe the outer shape of a body and imply that everything inside a shot surface must belong to the volume of this body. The volume of the body and the surrounding space is now divided into a large number of voxels (a voxel grid) and these voxels are assigned at least the index to the nearest surface segment and/or position information (inside, outside or on the edge).

It should be noted that the entire body does not have to be subdivided by the voxel grid. Basically, it is sufficient to define an area of the body that is to be changed (e.g. structured) and then subdivide it by the voxel grid. It can also be assumed that a “structural area” is defined and this is subdivided by a voxel grid.

Position information could be sufficient to modify the model. Using voxels that are assigned position information, it could e.g. be decided what to do with these voxels when applying Boolean operators in relation to a second body. For example, if the second body was a grid with a regular structure and this was to be cut out of the model (or an intersection formed), it would simply be necessary to check for each voxel of the model whether it lies on a voxel of the body and, if so, to remove this voxel (when cutting it out) or keep it (when forming the intersection), provided its position information indicates that it lies within the model. Voxels outside the model (given by position information) are removed. All remaining voxels of the model then result in the modified model.

If the position function is used alone, a voxel model is obtained in which a distinction is made between filled and unfilled voxels and whose surface can be further improved. This can be achieved in particular through the distance information and the index. The invention thus offers the possibility of generating surfaces that are implicitly described by a distance field. This allows implicit geometries with an accurately defined surface to be generated. Distance information is stored in the voxels, from which the surface can be reconstructed. Boolean operations can be carried out very easily with this distance information. For example, a merging of two bodies is the minimum of both distance information. A difference of two bodies can be represented by max(a,−b) with the distance information a and b of the two bodies. In terms of the invention, the index is very advantageous for calculating the exact distance, i.e. for any points that do not have to lie on the voxel grid (i.e. somewhere between the voxel centers).

### BRIEF DESCRIPTION OF THE DRAWINGS

The invention is explained in more detail below with reference to the attached figures using embodiments. In the various figures, identical components are labelled with identical reference numbers. The figures show

FIG. 1 is a schematic view, partially shown in section, of an embodiment of a manufacturing device for additive manufacturing with a modification device according to the invention,

FIG. 2 a model with a voxel grid encompassing and surrounding this model,

FIG. 3 a model with voxels and different position information,

FIG. 4 two voxel grids of different fineness,

FIG. 5 shows voxels to which different information is assigned according to their position,

FIG. 6 a two-dimensional representation of a fine grid of voxels with distance information and a coarser grid of voxels with indices only,

FIG. 7 a block diagram of the method.

### DETAILED DESCRIPTION OF THE EMBODIMENTS

The following embodiments are described with reference to a manufacturing device 1 for the additive manufacturing of components in the form of a selective laser sintering or laser melting device, it being explicitly pointed out once again that the invention is not limited to selective laser sintering or laser melting devices.

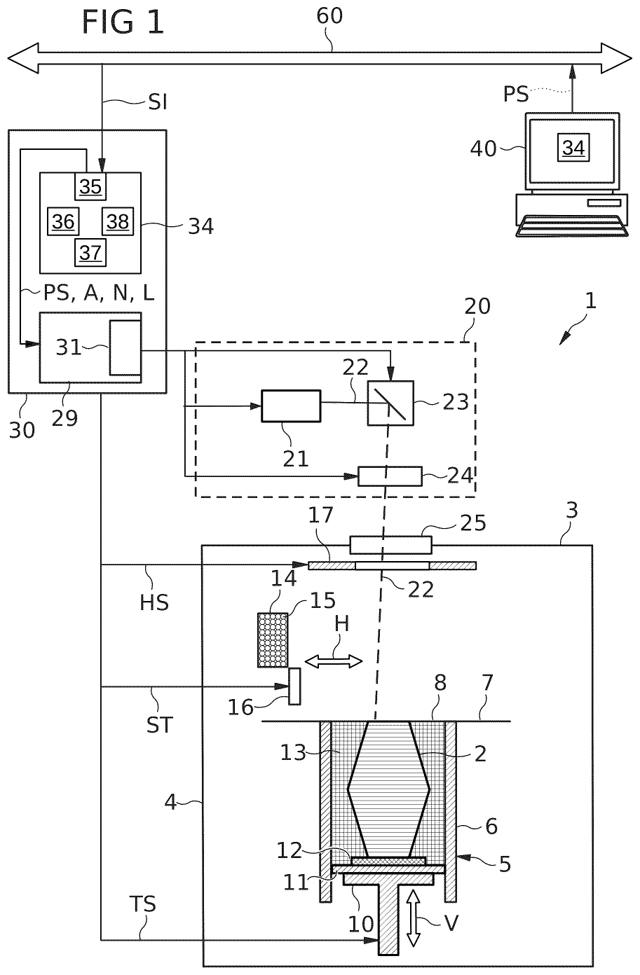

Such a manufacturing device 1 is shown schematically in FIG. 1. It has a process chamber 3 or a process space 3 with a chamber wall 4, in which the manufacturing process essentially takes place. In the process chamber 3 there is an upwardly open container 5 with a container wall 6. The upper opening of the container 5 forms the current working plane 7. The area of this working plane 7 located inside the opening of the container 5 can be used to construct the object 2 and is therefore referred to as the construction field 8.

The container 5 has a base plate 11 movable in a vertical direction V, which is arranged on a beam 10. This base plate 11 closes the container 5 at the bottom and thus forms its base. The base plate 11 can be formed integrally with the beam 10, but it can also be a plate formed separately from the beam 10 and attached to the beam 10 or simply mounted on it. Depending on the type of specific building material, for example the powder used, and the manufacturing process, a building platform 12 can be attached to the base plate 11 as a building base on which the object 2 is built. In principle, however, the object 2 can also be built on the base plate 11 itself, which then forms the building base.

The basic construction of the object 2 is carried out by first applying a layer of building material 13 to the building platform 12, then selectively solidifying the building material 13 with a laser beam 22 as an energy beam at the points which are to form parts of the object 2 to be manufactured, then lowering the base plate 11, thus the building platform 12, with the aid of the beam 10 and applying a new layer of the building material 13 and selectively solidifying it, and so on. In FIG. 1, the object 2 built up in the container on the building platform 12 is shown below the working plane 7 in an intermediate state. It already has several solidified layers, surrounded by unconsolidated building material 13. Various materials can be used as building material 13, preferably powder, in particular metal powder, plastic powder, ceramic powder, sand, filled or mixed powders or pasty materials, as well as optionally a mixture of several materials.

Fresh building material 15 is located in a storage container 14 of the production device 1. The building material can be applied in the working plane 7 or within the construction field 8 in the form of a thin layer with the aid of a coater 16 that can be moved in a horizontal direction H.

Optionally, there is an additional radiation heater 17 in the process chamber 3, which can be used to heat the applied building material 13 so that the irradiation device used for selective solidification does not have to introduce too much energy. This means, for example, that a quantity of basic energy can already be introduced into the building material 13 with the aid of the radiation heater 17, which is of course still below the energy required for the building material 13 to fuse or sinter. For example, an infrared heater or VCSEL heater can be used as the radiation heater 17.

For selective solidification, the manufacturing device 1 has an irradiation device 20 or, more specifically, an exposure device 20 with a laser 21. This laser 21 generates a laser beam 22, which is deflected by a deflection device 23 in order to scan the exposure paths or tracks (hatch lines) in the layer to be selectively solidified in accordance with the exposure strategy and to selectively introduce the energy. Furthermore, this laser beam 22 is suitably focused on the working plane 7 by a focusing device 24. The irradiation device 20 is preferably located here outside the process chamber 3 and the laser beam 22 is guided into the process chamber 3 via a coupling window 25 attached to the top of the process chamber 3 in the chamber wall 4.

For example, the irradiation device 20 may comprise not just one, but several lasers. Preferably, these may be gas or solid-state lasers or any other type of laser such as laser diodes, in particular VCSEL (Vertical Cavity Surface Emitting Laser) or VECSEL (Vertical External Cavity Surface Emitting Laser) or a line of these lasers. One or more unpolarized single-mode lasers, e.g. a 3 kW fiber laser with a wavelength of 1070 nm, can be used with particular preference in the context of the invention.

A control device 30 comprising a control unit 29, which controls the components of the irradiation device 20, namely here the laser 21, the deflection device 23 and the focusing device 24, is used to control the units of the production device 1.

The control unit 29 also controls the radiation heater 17 by means of suitable heating control data HS, the coater 16 by means of layer control data ST and the movement of the beam 10 by means of layer control data TS, thus controlling the layer thickness.

In order to subsequently modify image data transferred to the production device 1, e.g. to provide it with a structure, the latter comprises a modification device 34, which in this example is designed to generate control data PS directly from a modified model.

The modification device 34 is used to modify surface-based image data O of a three-dimensional geometric model M of the component 2. The image data O comprises surface data O of the model M with geometric information about a plurality of surface segments S, which together form the surface of the model M. The modification device 34 comprises a data interface 35 designed to receive this image data O and to output voxels X, X₁ with information N, L, A assigned to them. The modification device 34 here comprises a data interface 35 which is designed to receive this image data O and to output voxels X, X₁ with the information N, L, A assigned to them. These voxels form an image data set which, however, is not (purely) surface-based. In addition, the data interface 34 can also be designed to output the control data PS to the device for additive manufacturing of a component 2.

In addition, the modification device 34 also comprises an index-unit 36, a limiting-unit 37 and a process-unit 38.

The index-unit 36 is designed to assign an individual index N to at least some of the surface segments S. It assigns an index N in such a way that each indexed surface segment S can be distinguished from all other indexed surface segments S of the model M by means of its index N. This can be done by creating a separate number or character combination for each surface segment S. For example, since each surface segment S has a center of gravity at which no other center of gravity is located, an index could be the coordinate of the center of gravity.

The limiting-unit 37 is configured to create a number of voxel grids G, G1 each comprising a plurality of voxels X, X₁, wherein each voxel grid G, G1 comprises and surrounds at least a portion of the indexed surface segments S. These surface segments are thus located within the voxel grids.

The process-unit 38 is designed for several functions, namely for determining a position information L, which indicates whether the respective voxel X, X₁ lies inside or outside the contours of the model M, and assigning the position information L to the respective voxel X, X₁ and/or for assigning the index N of the nearest surface segment S to the respective voxel X, X₁ and/or for determining a distance A of the respective voxel X, X₁ to the contours of the model M, X₁ and/or for assigning the index N of the nearest surface segment S to the respective voxel X, X₁, and/or for determining a distance A of the respective voxel X, X₁ from the surface of the model M and assigning corresponding distance information A to the respective voxel X, X₁.

The modification device 34 is preferably also designed to create control data PS for the layer-by-layer construction of a component 2 based on a modified model M. Further preferably, the modification device can be designed for determining variables from the modified model M. Based on the variables, the control data PS or additional control data PS can be output.

The modification device 34 does not necessarily have to be part of the control device 30, even if this is preferred. It can also be external. For example, as shown here, the control device 30 can be coupled to a terminal 40 with a display or the like via a bus 60 or another data connection. Via this terminal 40, an operator can control the control device 30 and thus the entire laser sinter device 1, for example by transmitting control data PS that has been generated there by a modification device 34 (as indicated by a dashed line).

At this point, it is also pointed out once again that the present invention is not limited to such a manufacturing device 1. It can be applied to other methods for generative or additive manufacturing of a three-dimensional object by layer-by-layer deposition and selective solidification of a building material, wherein an energy beam for solidification is emitted onto the building material to be solidified. Accordingly, the irradiation device may also not only be a laser as described herein, but any device could be used with which energy can be selectively applied to or into the building material as wave or particle radiation. For example, another light source, an electron beam, etc. could be used instead of a laser.

Even if only a single object 2 or component 2 is shown in FIG. 1, it is possible and generally also common to produce several objects in the process chamber 3 or in the container 5 in parallel. For this purpose, the building material is scanned layer by layer by the energy beam 22 at points that correspond to the cross-sections of the objects in the respective layer.

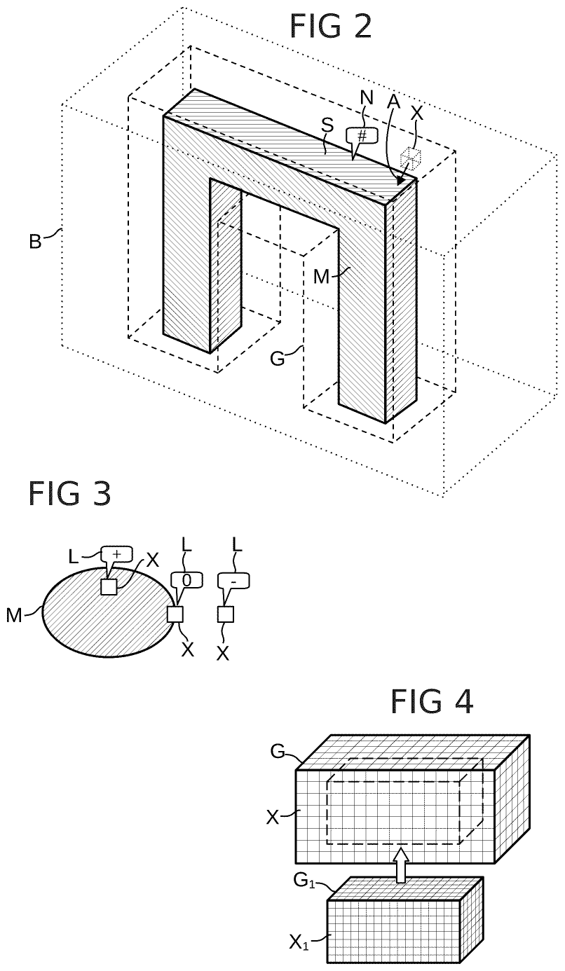

FIG. 2 shows a model M similar in shape to a horseshoe magnet with a voxel grid G encompassing and surrounding this model M. In this example, the model M is surrounded by a bounding box B, which originates from a segmentation of the model M. The model M itself is formed by surface data O, which here represents surface-based image data O. The model M itself is formed by surface data O, which here represents the surface-based image data O. Within the bounding box B, a voxel grid G of voxels X was defined, which has the model M inside it.

It should be noted that the bounding box B itself can form the volume for a voxel grid G, i.e. it can be subdivided into a voxel grid G. The drawing may also by all means be regarded as an example of two voxel grids G, assuming such a subdivision of bounding box B into voxels X. Alternatively, the bounding box can be seen as a voxel grid consisting of a single voxel. In other words, the bounding box according to the disclosure of FIG. 4 (see below) can be seen as a voxel grid with the lowest possible resolution (one voxel).

Each of the surface segments S is assigned an individual index N, which is symbolized here by a ‘#’ as a number. For example, the top rectangle could have 1, the side rectangles 2 and 3, the horseshoe-shaped surfaces 4 and 5, the inner surfaces 6 and 7 and the square base surfaces 8 and 9.

A voxel X of the voxel grid G is shown here as a dotted cube, the distance A of which is measured. This distance A is always the shortest distance A to the nearest surface segment S. In the above example, the index N “1” would therefore be assigned to the voxel X.

FIG. 3 shows a simple model M with voxels X and different position information L. Although the model is shown in two dimensions, it is intended to be three-dimensional. It is easy to imagine the figure as a top view of a thin disc. One voxel X is indicated inside the model M and carries the position information L “+” and one voxel X is indicated outside the model M and carries the position information L “−”. A third voxel X lies exactly on the edge of the model, i.e. it is penetrated by a surface segment S. The position information L “0” is assigned to this voxel X.

FIG. 4 shows two differently fine voxel grids G, G₁ with different resolutions and sizes of the voxels X, X₁. A first, coarser and larger voxel grid G is indicated at the top and a finer and smaller voxel grid G₁ at the bottom. The dashed contour in the first voxel grid G is intended to indicate that the second voxel grid G₁ is located inside the first voxel grid G (see arrow). A model M can be imagined inside the second voxel grid G₁, which is thus surrounded and enclosed by both voxel grids G, G₁.

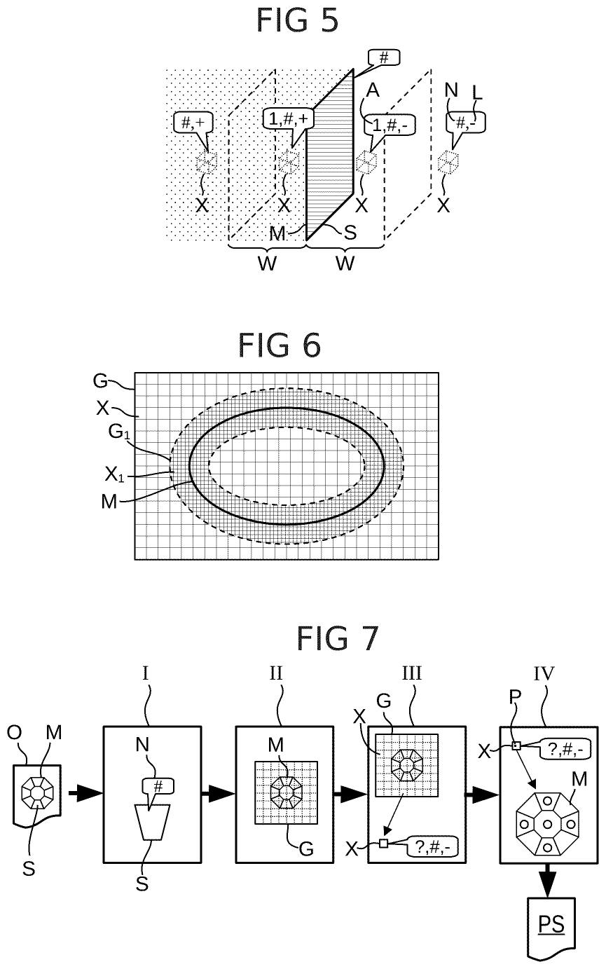

FIG. 5 shows voxels X, to which different information N, L, A is assigned according to their position. The dotted area symbolizes the interior of a model M. A total of four voxels X are shown at different positions. On the far left is a voxel X in the interior of the model M. This is assigned position information L and the index N of the nearest surface segment S (hatched area). As the distance of the voxel X to the surface segment S is greater than a specified threshold value W, which is indicated here by two hatched areas, no distance information A is assigned to this voxel X.

The distance A of the next voxel X (from left to right) to the surface segment S is smaller than the specified threshold value W. Therefore, in addition to position information L and an index N, a distance information A is also assigned to this voxel.

The distance A of the next voxel X (from left to right) to the surface segment S is also smaller than the specified threshold value W, but it lies outside the model M. Therefore, in addition to position information L (now “−”) and an index N, a distance information A is also assigned to this voxel.

The voxel X on the far right is outside the threshold value. As with the voxel on the far left, only position information L and an index N are assigned to it.

FIG. 6 shows a two-dimensional representation of a fine grid G₁ consisting of voxels X₁ with distance information A and a coarser grid G consisting of voxels X only with indices N and position information L. The coarser grid G can be created first and the information assigned to its voxels X. Then the second, finer voxel grid G can be created from the volume of those voxels X of the coarser grid. The second, finer voxel grid G₁ can then be created from the volume of those voxels X of the coarser grid through which the surface of the model M runs (e.g. by further subdividing the respective voxels X into finer voxels X₁). Additional distance information A can then be added to these.

FIG. 7 shows a block diagram of the process for modifying surface-based image data O of a three-dimensional geometric model M, suitable for the additive manufacturing of a component.

The image data O is shown on the far left as input data. This image data O comprises surface data O of the model M with geometric information about a plurality of surface segments S, which together form the surface of the model M. For example, this is an STL file of a model M that has been previously scanned or created using a CAD program.

In step I, each surface segment S of the model M is assigned an individual index N of the image data O in such a way that each indexed surface segment S can be distinguished from all other indexed surface segments S of the model M on the basis of its index N.

In step II, a voxel grid G with a large number of voxels X is created. This voxel grid G surrounds the model M and encompasses this model M, i.e. the model is “filled” by voxels X of the voxel grid G.

In step III, position information L is determined for each voxel X of the voxel grid G, which indicates whether the respective voxel X lies inside or outside the contours of the model M and is assigned to the respective voxel X. In addition, the index N of the nearest surface segment S is assigned to the respective voxel X, and the distance of the respective voxel X from the surface of the model M is also determined and assigned to the respective voxel X.

In step IV, the model M is modified by using the voxel data to represent an implicit representation of model M. This implicit representation is combined with another implicit surface, for example a repeating structure. The combination results in a new implicit surface that represents the modified model M.

This can be done in particular by assigning an index N of a surface segment S to voxels X and performing the following steps for a plurality of points P:
Select a point P, in a voxel X,
Determine the distance of the point P from the surface segment S to which the relevant index N is assigned.

In practice, the following steps are advantageous:
Check whether the index N differs from the index N of a neighboring voxel, and if so: Determine the distance of the point P from the surface segment S to which the relevant index N of the neighboring voxel is assigned,
Compare the distances determined and select the smallest distance.

Control data PS is then output based on the modified model M. Optionally, (e.g. geometric) variables can be determined from the modified model M and the control data PS can be output alternatively or additionally based on the variables. For example, contours can be extracted from the implicit surface of the modified model M or surface segments can be calculated.

Finally, it is pointed out once again that the devices described in detail above are merely embodiments which can be modified by the skilled person in a wide variety of ways without departing from the scope of the invention. Furthermore, the use of the indefinite articles “a” or “one” does not exclude the possibility that the respective features may be present more than once. Similarly, the term “unit” does not exclude the possibility that it comprises several interacting sub-components, which may also be spatially distributed. The phrase “a number” is to be understood as “at least one”.

### LIST OF REFERENCE SYMBOLS

1 Device for additive manufacturing/laser sinter device
2 Component/object
3 Process space/process chamber
4 Chamber wall
5 Container
6 Container wall
7 Working plane
8 Construction field
10 Beams
11 Base plate
12 Building platform
13 Building material (in container 5)
14 Storage container
15 Building material (in storage container 14)
16 Coater
17 Radiation heater
20 Irradiation device/exposure device
21 Laser
22 Laser beam/energy beam
23 Deflection device/scanner
24 Focusing device
25 Coupling windows
29 Control unit
30 Control device
31 Irradiation control interface
34 Modification device
35 Data interface
36 Index-unit
37 Limiting-unit
38 Process-unit
40 Terminal
60 Bus
A Distance information/distance
B Bounding volume/bounding box
G, G₁ Voxel grid
H horizontal direction
HS Heating control data
L Position information
M model
N Index
O Surface data
Point
PS Process control data
S Surface segment
SI layer information
ST Layer information
TS Layer control data
V vertical direction
W Threshold value
X Voxel
X₁ small voxel

What is claimed is:

1. A method for modifying surface-based image data of a three-dimensional geometric model suitable for the additive manufacturing of a component, the image data comprising surface data of the model with geometric information about a plurality of surface segments which together form the surface of the model, the method comprising the steps:
creating a number of voxel grids each comprising a plurality of voxels, wherein each voxel grid comprises and surrounds at least a part of the surface segments,
for the voxels of the voxel grids:
a) determining position information indicating whether the respective voxel lies inside or outside the contours of the model, and assigning the position information to the respective voxel and/or
b) assigning an individual index to at least some of the surface segments of the image data, so that each indexed surface segment is distinguishable from all other indexed surface segments of the model by means of its index, and assigning the index of the nearest surface segment to the respective voxel, and/or
c) determining a distance of the respective voxel to the surface of the model and assigning corresponding distance information to the respective voxel,
outputting the voxels with the information assigned to the voxels.

2. The method according to claim 1, wherein first voxels, which are assigned a same index and/or a same position information, are combined to form a group, wherein second voxels, which are assigned distance information, are treated as individual voxels.

3. The method according to claim 1, wherein a plurality of voxel grids of different resolution and/or different sizes are created and the assignment of corresponding distance information and/or an index and/or a position information to the respective voxel is carried out depending on in which voxel grid the voxel is located,
wherein at least a first voxel grid and a second voxel grid are defined in such a way that the first voxel grid has a coarser resolution than the second voxel grid and/or is larger than the second voxel grid wherein when the first voxel grid is larger than the second voxel grid the second voxel grid lies within the first voxel grid.

4. The method according to claim 3, wherein only voxels which have a distance less than a predetermined maximum distance from the surface are assigned distance information, wherein the maximum distance in the first voxel grid is greater than in the second voxel grid, or in the first voxel grid the voxels are assigned position information and/or an index and no distance information,
wherein each voxel to which distance information is assigned is also assigned at least one piece of position information.

5. The method according to claim 1, wherein for the determination of distance information and/or index and/or position information
a voxel grid is parsed voxel by voxel, the relevant value is determined and assigned for each voxel of the voxel grid, and when determining the distance, the shortest distance to the surface of the model is determined starting from each parsed voxel, or
the model is parsed surface segment by surface segment and for the voxels surrounding the respective surface segment, the value relating to each voxel is determined and assigned to the respective voxel,
wherein, in the context of a check with respect to a voxel to be checked, the voxels surrounding the voxel to be checked are checked to see whether an index of a surface segment other than the voxel to be checked has been assigned to them and, in the positive case, the distance of the voxel to be checked from the other surface segment is additionally determined and it is determined whether this distance is smaller than the distance to the voxel to be checked, to be checked and, in the positive case, the distance of the voxel to be checked from the other surface segment is also determined and it is determined whether this distance is smaller than the distance from the originally assigned surface segment.

6. The method according to claim 1, wherein voxels of a voxel grid, the finest voxel grid, are assigned an index of a surface segment, and wherein the following steps are carried out for a plurality of points:
selecting a point in a voxel of the voxel grid,
determining the distance of the point from the surface segment to which the relevant index is assigned,
whereby the further steps are carried out:
checking whether the index differs from the index of a neighbouring voxel, and if so:
determining the distance of the point from the surface segment to which the relevant index of the neighboring voxel is assigned,
comparing the distances determined and select the smallest distance.

7. The method according to claim 6, wherein the voxels of the voxel grid are additionally assigned distance information, and the distance of the point from the surface segment is only determined if the distance of the voxel which can be read from the distance information falls below a maximum distance and/or wherein the voxels of the voxel grid are additionally assigned position information, and this position information is assigned to the point, wherein, in the case that the position information indicates a position of the voxel on the edge, the corresponding position information for the point is additionally calculated.

8. The method according to claim 1, wherein the outputted voxels with the information assigned to them are used to create sectional planes of the model, for an additive manufacturing procedure, wherein the model is a modified model.

9. The method according to claim 1, wherein the outputted voxels with the information assigned to them are used to generate control data for a manufacturing device for the additive manufacturing of a component in a manufacturing process, in which building material is built up in layers in a construction field, comprising a metal powder, is built up in layers in a construction field and selective solidification of building material takes place between the application of two material layers of building material in that the building material is irradiated with at least one energy beam.

10. A modification device for modifying surface-based image data of a three-dimensional geometric model suitable for the additive manufacturing of a component, the image data comprising surface data of the model with geometric information about a plurality of surface segments which together form the surface of the model, the modification device comprising:
a data interface designed to receive the image data,
a limiting-unit designed for creating a number of voxel grids each comprising a plurality of voxels, wherein each voxel grid comprises and surrounds at least a part of the surface segments,
a process-unit designed for:
a) determining position information indicating whether the respective voxel lies inside or outside the contours of the model, and assigning the position information to the respective voxel and/or
b) assigning the index of the nearest surface segment to the respective voxel, wherein the modification device comprises an index-unit designed for assigning an individual index to at least some of the surface segments, so that each indexed surface segment is distinguishable by its index from all other indexed surface segments of the model, and/or
c) determining a distance of the respective voxel to the surface of the model and assigning corresponding distance information to the respective voxel,
a data interface designed for outputting the voxels with the information assigned to them.

11. A control device for a manufacturing apparatus for the additive manufacturing of a component in a manufacturing process, in which building material, comprising a metal powder, is built up in layers in a construction field and selective solidification of building material takes place in each case between the application of two material layers of building material in that in that the building material is irradiated with at least one energy beam by means of an irradiation device, the control device comprising a modification device according to claim 10.

12. A manufacturing device for the additive manufacturing of at least one component in an additive manufacturing process comprising at least
a feeding device for applying material layers of building material in a construction field into a process space,
an irradiation device for selectively solidifying building material between the application of two layers of material by irradiation with at least one energy beam, and
a control device according to claim 11.

13. A data set comprising surface-based image data of a model together with control data for controlling a manufacturing device for additive manufacturing, which have been generated according to a method according to claim 9.

14. A manufacturing procedure for the additive manufacturing of a component, wherein building material, comprising a metal powder, is built up in layers in a construction field and selective solidification of building material takes place in each case between the application of two material layers of building material in that the building material is irradiated with at least one energy beam based on image data which have been modified by means of a procedure according to claim 1.

15. A computer program product having a computer program which can be loaded directly into a control device of a manufacturing device for the additive manufacturing of a component layer of a component, having program sections in order to carry out all the steps of the method according to claim 1 when the computer program is executed in the computing device.
